(19) United States
(12) Patent Application Publication
(10) Pub. No.: US 2026/0219656 A1
(43) Pub. Date: Jul. 30, 2026

(54) PRODUCTION INFORMING DEVICE AND PRODUCTION INFORMING METHOD

(71) Applicant: FUJI CORPORATION, Chiryu (JP)

(72) Inventors: Mitsuru SANJI, Toyota-shi (JP); Kenji HARA, Kariya-shi (JP)

(73) Assignee: FUJI CORPORATION, Chiryu (JP)

(21) Appl. No.: 19/145,577

(22) PCT Filed: Feb. 1, 2023
(86) PCT No.: PCT/JP2023/003231

§ 371 Date: Jul. 3, 2025

(51) Int. Cl. G05B 19/418

(52) U.S. Cl. CPC G05B 19/4188; G05B 2219/32088

(57) ABSTRACT

A production informing device includes a calculation section and an informing section. The calculation section is configured to, based on the remaining number of articles suppliable from a device used in a board work machine configured to perform predetermined board work on a board to produce a product board, in an entire production line including the board work machine, calculate a production continuable time that is a time during which the board work machine is capable of continuing the production of the product board using the articles remaining in the production line. The informing section is configured to inform a worker of the production line about the production continuable time calculated by the calculation section.

### TECHNICAL FIELD

The present description discloses a technique related to a production informing device and a production informing method.

### BACKGROUND ART

An inventory management device disclosed in Patent Literature 1 includes a component remaining number calculating section, a replenishment instruction generation section, and a replenishment instruction output section. The component remaining number calculating section calculates a time until a replenishment timing for performing splicing work. The component remaining number calculating section transmits remaining time information indicating the time until the replenishment timing calculated for each input port of an electronic component mounter, to the replenishment instruction generation section.

The replenishment instruction generation section determines whether there is the input port of the electronic component mounter in which the time until the replenishment timing is equal to or less than a threshold based on the remaining time information received from the component remaining number calculating section. When there is the input port of the electronic component mounter in which the time until the replenishment timing is equal to or less than the threshold, the replenishment instruction generation section generates replenishment instruction information for instructing splicing work of the electronic components of the reel set in the input port of the electronic component mounter, and transmits the replenishment instruction information to the replenishment instruction output section. The replenishment instruction output section outputs the replenishment instruction information received from the replenishment instruction generation section.

### CITATION LIST

### Patent Literature

Patent Literature 1: WO 2017/145625

### BRIEF SUMMARY

### Technical Problem

When an article remaining in a production line and supplied from a device is insufficient, the production of a product board is stopped in a board work machine. Therefore, there is a demand for the board work machine to inform a worker about a production continuable time, which is a time during which the production of the product board can be continued using the article remaining in the production line.

In view of such circumstances, the present description discloses a production informing device and a production informing method capable of informing a worker about a production continuable time.

### Solution to Problem

The present description discloses a production informing device including a calculation section and an informing section. The calculation section is configured to, based on the remaining number of articles suppliable from a device used in a board work machine configured to perform predetermined board work on a board to produce a product board, in an entire production line including the board work machine, calculate a production continuable time that is a time during which the board work machine is capable of continuing the production of the product board using the articles remaining in the production line. The informing section is configured to inform a worker of the production line about the production continuable time calculated by the calculation section.

The present description discloses a production informing method including a calculation step and an informing step. In the calculation step, based on the remaining number of articles suppliable from a device used in a board work machine configured to perform predetermined board work on a board to produce a product board, in an entire production line including the board work machine, a production continuable time that is a time during which the board work machine is capable of continuing the production of the product board using the articles remaining in the production line is calculated. In the informing step, a worker of the production line is informed about the production continuable time calculated by the calculation step.

### Advantageous Effects

With the production informing device described above, it is possible to inform the worker about the production continuable time. Therefore, the worker is able to understand the production continuable time and can recognize a deadline for preparing the device. The above description regarding the production informing device can be similarly applied to the production informing method.

### BRIEF DESCRIPTION OF DRAWINGS

FIG. 1 is a plan view illustrating a configuration example of a board production line.

FIG. 2 is a perspective view illustrating a configuration example of an exchange system and a component mounter illustrated in FIG. 1.

FIG. 3 is a plan view illustrating an example of an exchange operation of a feeder between a conveyance device and a component supply device of the component mounter.

FIG. 4 is a block diagram illustrating an example of control blocks of a production informing device.

FIG. 5 is a flowchart illustrating an example of a control procedure performed by the production informing device.

FIG. 6 is a schematic diagram illustrating a first example of a temporal change in the remaining number of articles.

FIG. 7 is a schematic diagram illustrating a second example of the temporal change in the remaining number of articles.

FIG. 8 is a schematic diagram illustrating an example of informing about a production continuable time.

### DESCRIPTION OF EMBODIMENTS

### 1. Embodiment

### 1-1. Configuration Example of Production Line WL0

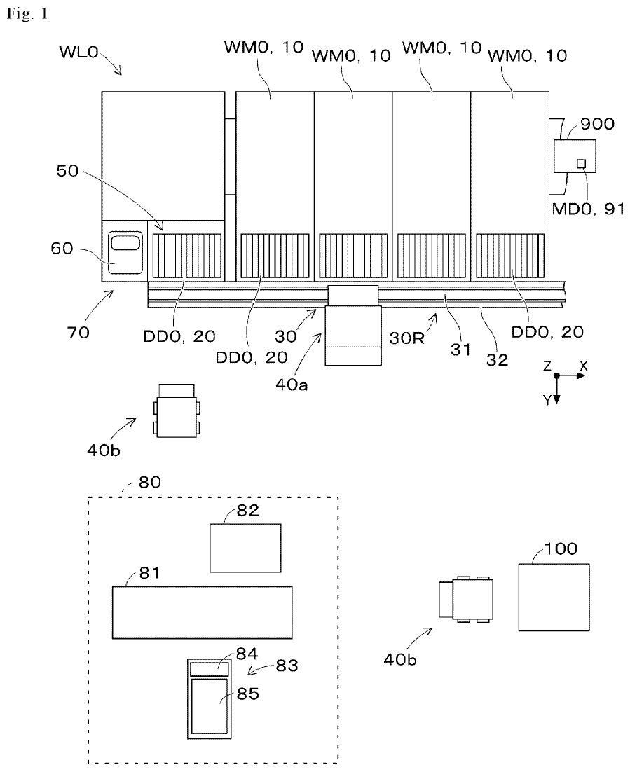

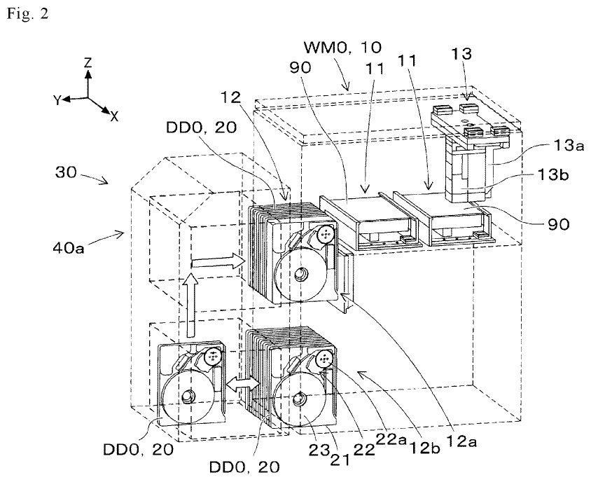

Production informing device 70 of the embodiment is applied to production line WL0. As illustrated in FIG. 1, production line WL0 includes at least one component mounter 10 (four in the same drawing), exchange system 30, conveyance device 40a, storage device 50, and line management device 60. Four component mounters 10 are installed along a conveyance direction (X direction) of board 90 illustrated in FIG. 2. Component mounter 10 is included in board work machine WM0 that performs predetermined board work on board 90. The board work performed by component mounter 10 includes carrying-in work and carrying-out work of board 90, and supply work, pick-up work, mounting work, and the like of component 91. Cassette-type feeder 20 is, for example, detachably provided in component mounter 10.

Storage device 50 used for storing feeder 20 is installed, for example, on a board carrying-in side of production line WL0 (on a left side in the drawing in FIG. 1). In addition, exchange system 30 and conveyance device 40a are provided in production line WL0, and perform supply work, an exchange operation, and collection work of feeder 20. The configuration of production line WL0 may be added as appropriate or changed in accordance with, for example, a type of product board 900 to be produced. Specifically, board work machine WM0 such as a solder printer, a solder inspector, a reflow oven, and a visual inspector can be installed as appropriate in production line WL0. As described above, production line WL0 can subsequently convey board 90 by using various board work machines WM0, execute a production process including an inspection process, and produce product board 900.

Board work machine WM0 constituting production line WL0 is configured to input and output various data to and from line management device 60 via a network. For example, storage device 50 includes multiple slots. Storage device 50 stocks feeders 20 installed in the multiple slots. Feeder 20 installed in the slot of storage device 50 is in a state of being capable of communicating with line management device 60. As a result, the slot of storage device 50 and identification information of feeder 20 installed in the slot are recorded in line management device 60 in association with each other.

In addition, line management device 60 monitors an operation status of production line WL0, and integrally controls board work machine WM0 such as component mounter 10, exchange system 30, conveyance device 40a, and storage device 50. Line management device 60 stores various data for controlling board work machine WM0, exchange system 30, conveyance device 40a, and storage device 50. Line management device 60 transmits various data such as a production program when, for example, component mounter 10 executes a mounting process of component 91.

### 1-2. Configuration Example of Component Mounter 10

As illustrated in FIG. 2, each of four component mounters 10 includes board conveyance device 11, component supply device 12, and head drive device 13. In the present description, the conveyance direction of board 90 is defined as the X direction. In addition, a direction orthogonal to the X direction in a horizontal plane is defined as a Y direction. Further, a vertical direction (up-down direction in the drawing in FIG. 2) orthogonal to the X direction and the Y direction is defined as a Z direction.

Board conveyance device 11 is configured with, for example, a belt conveyor and a positioning device. Board conveyance device 11 subsequently conveys board 90 in the conveyance direction (X direction) and positions board 90 at a predetermined position in the machine. Board conveyance device 11 carries board 90 out of component mounter 10 after the mounting process performed by component mounter 10 is completed.

Component supply device 12 supplies component 91 to be mounted on board 90. Component supply device 12 includes first slot 12a and second slot 12b that can be installed with multiple feeders 20. In the embodiment, first slot 12a is disposed in an upper portion of a front portion side of component mounter 10 to operably hold installed feeder 20. The operation of feeder 20 installed in first slot 12a is controlled in the mounting process performed by component mounter 10, and component 91 is supplied at a takeout section provided at a defined position at the upper portion of feeder 20. As described above, first slot 12a can hold feeder 20 used for the production of product board 900.

In the embodiment, second slot 12b is disposed below first slot 12a and stocks installed feeder 20. Specifically, second slot 12b preliminarily holds feeder 20 that is scheduled to be used for the production of product board 900. In addition, second slot 12b temporarily holds feeder 20 that is no longer necessary for the production of product board 900. The exchange operation of feeder 20 between first slot 12a and second slot 12b is performed by conveyance device 40a.

As illustrated in FIG. 2, feeder 20 includes feeder main body 21 and drive device 22. Feeder main body 21 of the embodiment is formed in a flat box shape. Feeder main body 21 detachably (exchangeably) holds reel 23 on which a carrier tape accommodating multiple components 91 is wound. Drive device 22 includes sprocket 22a that engages with a feeding hole provided in the carrier tape. Drive device 22 rotates sprocket 22a to feed and move the carrier tape.

The operation of drive device 22 of feeder 20 is controlled by a control device of component mounter 10. When feeder 20 is installed in first slot 12a of component mounter 10, feeder 20 receives power supplied from component mounter 10 via a connector, and is in a state of being capable of communicating with component mounter 10. As a result, component mounter 10 can detect the supply and the collection of feeder 20 in first slot 12a. The above description regarding first slot 12a can be similarly applied to second slot 12b.

The feeding operation of the carrier tape accommodating component 91, which is performed by feeder 20 installed in first slot 12a, is controlled based on a control instruction or the like by component mounter 10. As a result, feeder 20 supplies components 91 to be picked up by a holding member of mounting head 13b at the takeout section provided at the upper portion of feeder 20.

Head drive device 13 moves moving body 13a in the horizontal direction (X direction and Y direction) by a linear motion mechanism. Mounting head 13b is fixed to moving body 13a by a clamp member to be exchangeable (detachable). Mounting head 13b is moved in the X direction and the Y direction integrally with moving body 13a by the linear motion mechanism of head drive device 13. Mounting head 13b uses the holding member to pick up component 91 supplied by component supply device 12. As the holding member, for example, a suction nozzle that picks up component 91 by supplied negative pressure air, a chuck that grips component 91, or the like can be used.

Mounting head 13b holds the holding member to be movable in the Z direction and to be rotatable about a Q axis parallel to the Z direction. Mounting head 13b adjusts a position and an angle of the holding member in accordance with a posture of picked-up component 91. Mounting head 13b mounts component 91 at the mounting position on board 90 instructed by the production program. A total time of a time required for a predetermined number of cycles of a pick-and-place cycle of components 91 and a time required for carrying in and carrying out board 90 corresponds to a cycle time per board 90.

The holding member provided in mounting head 13b may be changed as appropriate in accordance with the type of component 91 in the mounting process of mounting component 91 on board 90. Component mounter 10 attaches the suction nozzle accommodated in a nozzle station to mounting head 13b, for example, when the suction nozzle used in the mounting process to be executed is not attached to mounting head 13b. The nozzle station is detachably installed at a predetermined position in component mounter 10 or on feeder 20.

### 1-3. Configuration Example of Exchange System 30 and Conveyance Device 40a

As illustrated in FIGS. 1 and 2, exchange system 30 includes first rail 31 and second rail 32. First rail 31 and second rail 32 form traveling path 30R of conveyance device 40a. First rail 31 extends in the conveyance direction (X direction) of board 90, and is provided between first slot 12a and second slot 12b in the vertical direction (Z direction).

Second rail 32 extends in the conveyance direction (X direction) of board 90, and is provided below second slot 12b in the vertical direction (Z direction). First rail 31 and second rail 32 extend over substantially the entire region of the conveyance direction (X direction) of board 90 in production line WL0. The conveyance direction (X direction) of board 90 corresponds to a disposition direction of four component mounters 10.

Conveyance device 40a is provided to be able to travel on traveling path 30R formed by first rail 31 and second rail 32. Conveyance device 40a receives power supplied from a power feeding section by non-contact power supply, for example, via a power receiving section provided to face the power feeding section provided on first rail 31. The power received by the power receiving section is used for traveling of conveyance device 40a, predetermined work, and the like via the power receiving circuit. Conveyance device 40a detects, for example, a position (current position) on traveling path 30R by using a position detection device. The position detection device can detect the position by using, for example, an optical detection method, a detection method using electromagnetic induction, or the like.

The predetermined work includes an exchange operation of exchanging device DD0 used for the production of product board 900 by board work machine WM0 such as component mounter 10, with board work machine WM0. Conveyance device 40a of the embodiment uses feeder 20 that supplies component 91 to be mounted on board 90 as device DD0, and performs the exchange operation of feeder 20 with component mounter 10 that is board work machine WM0. In addition, conveyance device 40a can perform the exchange operation of feeder 20 with storage device 50 using feeder 20 as device DD0.

Conveyance device 40a of the embodiment conveys feeder 20 from storage device 50 to first slot 12a or second slot 12b of component mounter 10, and performs the supply work of feeder 20. In addition, conveyance device 40a performs the exchange operation of feeder 20 between first slot 12a and second slot 12b of component mounter 10. Further, conveyance device 40a conveys feeder 20 that is no longer necessary, from component mounter 10 to storage device 50, and performs the collection work of feeder 20.

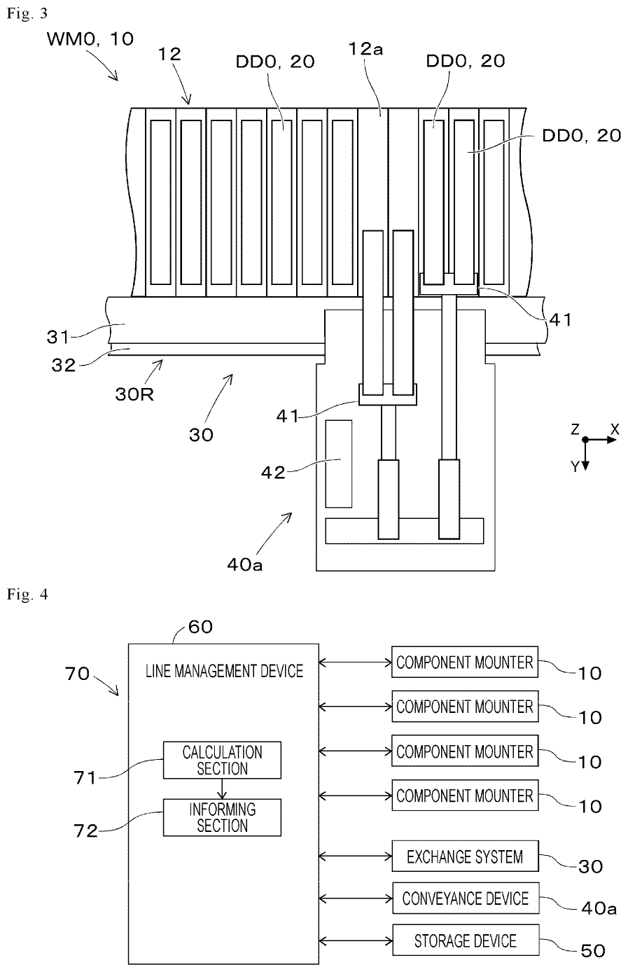

As illustrated in FIG. 3, conveyance device 40a includes at least one holding section 41 (two in the same drawing) and control device 42. In the embodiment, each of two holding sections 41 can simultaneously clamp multiple (two in the same drawing) feeders 20, and can simultaneously hold multiple (two) feeders 20. In addition, each of two holding sections 41 is independently movable along an attachment/detachment direction (Y direction in the embodiment) of feeder 20 by using, for example, the linear motion mechanism or the like, and can simultaneously move multiple (two) feeders 20 along the Y direction.

Further, two holding sections 41 are integrally movable in the vertical direction (Z direction) by using, for example, the linear motion mechanism or the like, and can simultaneously move multiple (four) feeders 20 in the Z direction. Also, conveyance device 40a may include, for example, multiple (four) holding sections 41. In this case, each of multiple (four) holding sections 41 can clamp one feeder 20, to independently move multiple (four) feeders 20 in the Y direction and the Z direction. In addition, the form of holding section 41 is not limited to the clamp mechanism and the linear motion mechanism, and can take various forms. For example, holding section 41 may include a protrusion portion that can be fitted into a hole portion provided in feeder 20. In this case, feeder 20 is held by fitting the protrusion portion of holding section 41 into the hole portion of feeder 20.

Control device 42 includes a well-known computing device and storage device, to constitute a control circuit. Control device 42 is connected to four component mounters 10, exchange system 30, storage device 50, and line management device 60 in a communicable manner. Control device 42 controls the traveling of conveyance device 40a, the operations of two holding sections 41, and the like. With the above-described configuration, conveyance device 40a can move to a predetermined position along first rail 31 and second rail 32, and can perform the exchange operation of feeder 20 at a stop position.

Storage device 50 can store not only feeder 20 but also device DD0 used for the production of product board 900 using board work machine WM0. For example, when board work machine WM0 is component mounter 10, device DD0 includes a tray unit that accommodates a tray on which multiple components 91 are arranged and a wafer component supply device that can supply wafer components. A holding member supply device (nozzle station when the holding member is the suction nozzle) capable of supplying the holding member (suction nozzle, chuck, or the like) is included in device DD0. When board work machine WM0 is a solder printer that prints solder on board 90, a solder container that accommodates solder is included in device DD0.

As described above, storage device 50 can preliminarily hold device DD0 that is scheduled to be used for the production of product board 900 or can temporarily hold device DD0 that is no longer necessary for the production of product board 900. Further, conveyance device 40a can supply not only feeder 20 but also device DD0 carried in storage device 50 to first slot 12a or second slot 12b, and can collect device DD0 that is no longer necessary for the production of product board 900 from first slot 12a or second slot 12b to storage device 50.

Further, board work machine WM0 may include not only component mounter 10 but also first slot 12a and second slot 12b, and device DD0 to be held is not limited to feeder 20. That is, board work machine WM0 includes first slot 12a that can hold device DD0 to be used for the production of product board 900, and second slot 12b that can preliminarily hold device DD0 that is scheduled to be used for the production of product board 900 or can temporarily hold device DD0 that is no longer necessary for the production of product board 900.

### 1-4. Configuration Example of Production Informing Device 70

In the present description, for example, component 91 supplied from feeder 20 or the tray unit or a component supplied from device DD0 such as solder supplied from the solder container is referred to as article MD0. When article MD0 supplied from device DD0 remaining in production line WL0 is insufficient, the production of product board 900 is stopped in board work machine WM0. Therefore, there is a demand for board work machine WM0 to inform the worker about production continuable time TM0 that is a time during which the production of product board 900 can be continued using article MD0 remaining in production line WL0.

Production line WL0 of the embodiment is provided with production informing device 70. Therefore, the worker is able to understand production continuable time TM0 and can recognize a deadline for preparing device DD0. Specifically, production informing device 70 includes calculation section 71 and informing section 72. Calculation section 71 and informing section 72 can be provided in various control devices, management devices, and the like. For example, at least one of calculation section 71 and informing section 72 can be provided in line management device 60. At least one of calculation section 71 and informing section 72 may be provided in a management device that manages multiple production lines WL0. At least one of calculation section 71 and informing section 72 may be formed on a cloud.

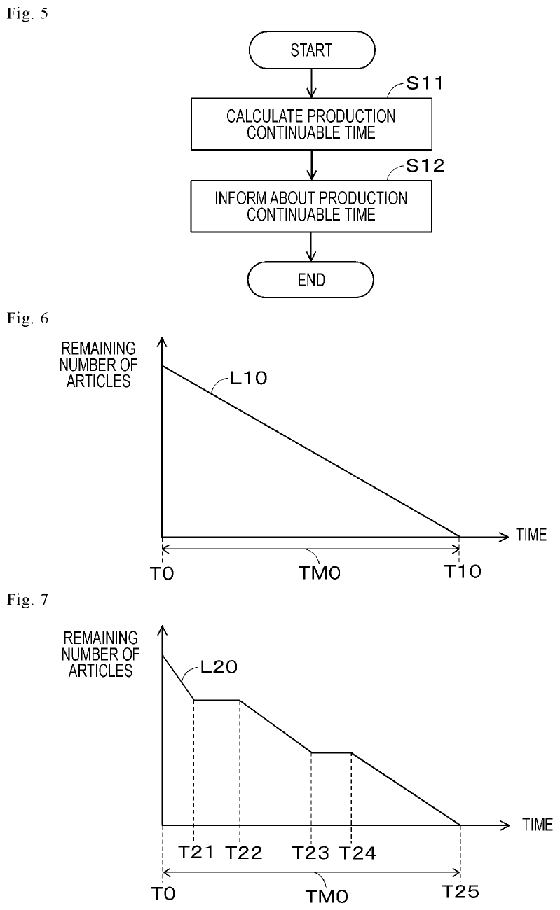

As illustrated in FIG. 4, calculation section 71 and informing section 72 of the embodiment are provided in line management device 60. Further, production informing device 70 executes control in accordance with a flowchart illustrated in FIG. 5. Calculation section 71 performs the processing illustrated in step S11. Informing section 72 performs the processing illustrated in step S12.

### 1-4-1. Calculation Section 71

Calculation section 71 calculates production continuable time TM0 based on the remaining number of articles MD0 that can be supplied from device DD0 used in board work machine WM0, in entire production line WL0 including board work machine WM0 (step S11 illustrated in FIG. 5).

The remaining number of articles MD0 in entire production line WL0 refers to the number of articles MD0 that can be supplied from device DD0 that can be used for the production of product board 900 without intervention of the worker. For example, as illustrated in FIGS. 1 and 2, board work machine WM0 includes first slot 12a and second slot 12b. Production line WL0 includes storage device 50 and conveyance device 40a. All of first slot 12a, second slot 12b, and storage device 50 can hold device DD0, and conveyance device 40a can move device DD0 between first slot 12a, second slot 12b, and storage device 50 without intervention of the worker.

Therefore, in production line WL0, article MD0 remaining in production line WL0 is article MD0 that can be supplied from device DD0 held in any of first slot 12a, second slot 12b, and storage device 50. Production continuable time TM0 is a time during which board work machine WM0 is capable of continuing the production of product board 900 using article MD0 remaining in production line WL0.

For example, when all articles MD0 are supplied from device DD0 held in first slot 12a, device DD0 held in second slot 12b or storage device 50 is moved to first slot 12a by conveyance device 40a, and articles MD0 are supplied from device DD0. When there is no device DD0 capable of supplying article MD0 in all of first slot 12a, second slot 12b, and storage device 50, board work machine WM0 cannot continue the production of product board 900 using article MD0 remaining in production line WL0. Therefore, a time from a current time to a scheduled time when article MD0 runs short in production line WL0 is production continuable time TM0.

For example, production line WL0 can continuously produce product boards 900 of the same type. In this case, calculation section 71 can calculate production continuable time TM0 based on the remaining number of articles MD0 in entire production line WL0 and a scheduled number of articles MD0 to be used per unit time. Straight line L10 in FIG. 6 indicates a first example of a temporal change in the remaining number of predetermined articles MD0. A vertical axis in the same drawing indicates the remaining number of articles MD0 in entire production line WL0 (first slot 12a, second slot 12b, and storage device 50), and a horizontal axis indicates a time. Further, time T0 indicates the current time, and time T10 indicates a time when the remaining number of articles MD0 becomes zero (a time when production continuable time TM0 becomes zero).

When production line WL0 continuously produces product boards 900 of the same type, the scheduled number of articles MD0 to be used per unit time in production line WL0 is constant. Therefore, as indicated by straight line L10, the remaining number of articles MD0 decreases at a constant rate and becomes zero at time T10. That is, production continuable time TM0 in this case is a time from time T0 to time T10.

Production line WL0 can also produce product board 900 based on a production plan in which a type, a production quantity, and a production period of product boards 900 to be produced, and device DD0 to be used for the production of product board 900 are planned. In this case, calculation section 71 can calculate production continuable time TM0 based on the remaining number of articles MD0 in entire production line WL0 and the scheduled number of articles MD0 to be used, which is expected when product board 900 is produced in accordance with the production plan.

Polygonal line L20 in FIG. 7 illustrates a second example of the temporal change in the remaining number of predetermined articles MD0. A vertical axis in the same drawing indicates the remaining number of articles MD0 in entire production line WL0 (first slot 12a, second slot 12b, and storage device 50), and a horizontal axis indicates a time. Further, time TO indicates the current time, and time T25 indicates a time when the remaining number of articles MD0 becomes zero (a time when production continuable time TM0 becomes zero).

In the production plan, the type, the production quantity, and the production period of product board 900 to be produced, and device DD0 to be used for the production of product board 900 are planned, and thus calculation section 71 can acquire the scheduled number of articles MD0 to be used by referring to the production plan. Therefore, calculation section 71 can acquire the temporal change in the remaining number of articles MD0 indicated by polygonal line L20. Production continuable time TM0 in this case is a time from time T0 to time T25.

When production line WL0 produces product board 900 in accordance with the production plan, the scheduled number of articles MD0 to be used per unit time in production line WL0 varies depending on a difference in the type of product board 900 to be produced. For example, a slope of polygonal line L20 is different in the time from time T0 to time T21, the time from time T22 to time T23, and the time from time T24 to time T25.

In addition, the remaining number of articles MD0 is constant and does not decrease in the time from time T21 to time T22 and the time from time T23 to time T24. This indicates that, depending on the type of product board 900 to be produced, device DD0 capable of supplying article MD0 of the type illustrated in the same drawing is not be used for the production in some cases.

The worker needs to prepare device DD0 to be supplied to production line WL0 before the remaining number of articles MD0 becomes zero (production continuable time TM0 becomes zero). Specifically, as illustrated in FIG. 1, work area 80 is provided in production line WL0. Work area 80 includes workbench 81, shelf 82, and mobile terminal 83. In work area 80, the worker performs kitting work, arrangement preparation work, cleanup work, and the like on device DD0.

For example, when device DD0 is feeder 20, the worker sets predetermined reel 23 on feeder 20 and enables supply to production line WL0. Specifically, the worker sets predetermined reel 23 on feeder 20 on workbench 81 (kitting work) and installs reel 23 on shelf 82. The worker can acquire reel 23 and feeder 20 from storage 100. Reel 23 and feeder 20 can also be acquired by cart 40b, such as an automated guided vehicle or an autonomous mobile robot, from storage 100 that is an automatic warehouse. The worker moves feeder 20 installed on shelf 82 with reels 23 set to cart 40b (arrangement preparation work). Then, cart 40b conveys feeder 20 on which reel 23 is set to storage device 50 of production line WL0.

In the kitting work, the worker reads an identification code attached to reel 23 using, for example, reading device 84 of mobile terminal 83 or the like. In addition, the worker reads an identification code attached to feeder 20 using reading device 84 of mobile terminal 83 or the like. Accordingly, identification information for identifying reel 23 and identification information for identifying feeder 20 are transmitted to an article management device that manages article MD0. When the identification information is acquired, the article management device stores the identification information of reel 23 and the identification information of feeder 20 in a storage device in association with each other. The article management device can also update location information of feeder 20 when feeder 20 moves, for example.

For example, when moving feeder 20 to shelf 82, the worker reads the identification code of feeder 20 using reading device 84 of mobile terminal 83 or the like. When mobile terminal 83 has a positioning function, mobile terminal 83 reads the identification code and transmits the location information of feeder 20 to the article management device. The article management device updates the location information of reel 23 and feeder 20 stored in the storage device to the received location information. The worker can also read a location code provided in work area 80 using reading device 84 of mobile terminal 83 or the like. Accordingly, positional information of the area in which the location code is provided is transmitted to the article management device, and the article management device similarly updates the location information. In addition, when feeder 20 is set in the slot of shelf 82 and power is supplied, the article management device can communicate with feeder 20 and update the location information of feeder 20.

Cart 40b conveys, for example, feeder 20 that is no longer necessary for the production of product board 900 from storage device 50 of production line WL0 to work area 80. In work area 80, the worker cleans up feeder 20 that is no longer necessary for the production of product board 900, as necessary (cleanup work). Specifically, the worker takes out reel 23 from feeder 20. Taken-out reel 23 is, for example, conveyed to storage 100 by cart 40b and stored in storage 100. In this case, a correspondence relationship between the identification information of reel 23 and the identification information of feeder 20 that are stored in the storage device is deleted. When the cleanup work is unnecessary, reel 23 and feeder 20 are stored in a set state on, for example, shelf 82. In this case, the correspondence relationship between the identification information of reel 23 and the identification information of feeder 20 that are stored in the storage device is maintained.

### 1-4-2. Informing Section 72

Informing section 72 informs the worker of production line WL0 about production continuable time TM0 calculated by calculation section 71 (step S12 illustrated in FIG. 5). Informing section 72 need only take various forms as long as informing section 72 can inform the worker about production continuable time TM0.

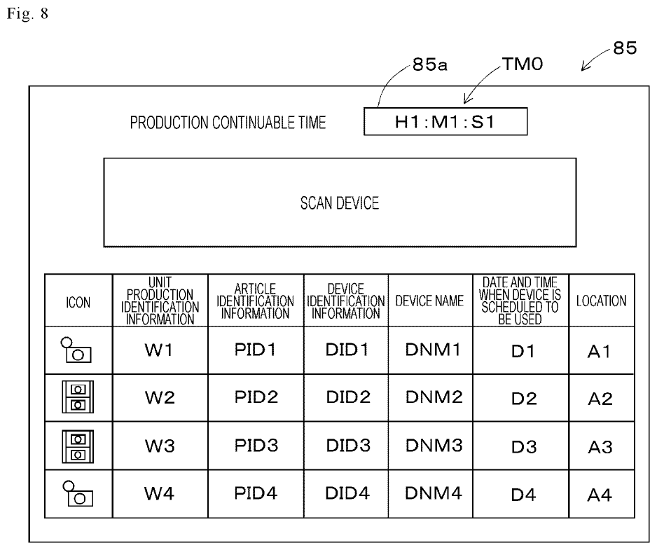

For example, calculation section 71 can generate a list of devices DD0 to be prepared by the worker, and informing section 72 can inform about the information related to device DD0 and production continuable time TM0 in the order of devices DD0 prepared by the worker. Specifically, calculation section 71 generates a list of devices DD0 illustrated in FIG. 8. Then, informing section 72 can inform about the information in display device 85 of mobile terminal 83 illustrated in FIG. 1. FIG. 8 illustrates an example of a display screen displayed on display device 85 of mobile terminal 83, in which an icon, unit production identification information, article identification information, device identification information, a device name, a date and time when the device is scheduled to be used, and a location are listed.

The icon schematically illustrates the work of device DD0 performed by the worker. For example, an uppermost icon and a lowermost icon in FIG. 8 indicate that the worker needs to perform the kitting work and the arrangement preparation work described above. A second icon and a third icon in the same drawing indicate that the kitting work has already been completed and the worker needs to perform the arrangement preparation work described above.

The unit production identification information is information capable of identifying the unit production. In the production plan, the order of multiple unit productions is defined. For example, when the type of product board 900 to be produced is switched, new unit production is set in the production plan. When the production lot is switched even when the type of product board 900 to be produced is the same, new unit production is set in the production plan. The same drawing illustrates that the unit production indicated by unit production identification information W1 to unit production identification information W4 is performed in this order.

The article identification information is information capable of identifying article MD0 supplied from device DD0. The same drawing illustrates that articles MD0 indicated by article identification information PID1 to article identification information PID4 are insufficient in this order (for example, when article MD0 is component 91, component shortage occurs). The device identification information is information capable of identifying device DD0. The same drawing illustrates that the worker has to prepare devices DD0 indicated by device identification information DID1 to device identification information DID4 in this order.

The device name refers to the name of device DD0. The same drawing illustrates that the names of devices DD0 indicated by device identification information DID1 to device identification information DID4 are represented by device name DNM1 to device name DNM4 in this order. The date and time when the device is scheduled to be used refers to a scheduled date and time when device DD0 is used in production line WL0, and corresponds to time T10 illustrated in FIG. 6 or time T25 illustrated in FIG. 7. Devices DD0 indicated by device identification information DID1 to device identification information DID4 are used at date and time D1 to date and time D4 in this order. Date and time D1 to date and time D4 are represented by month, date, hour, and minute. The location refers to the location of device DD0. Devices DD0 indicated by device identification information DID1 to device identification information DID4 are present at locations A1 to A4 in this order.

In addition, informing section 72 can display production continuable time TM0, for example, at the top of display device 85 of mobile terminal 83. Informing section 72 can display production continuable time TM0 for device DD0 (in FIG. 8, device DD0 indicated by device identification information DID1) to be prepared first by the worker. In FIG. 8, production continuable time TM0 of device DD0 indicated by device identification information DID1 is indicated by hour H1, minute M1, and second S1. When the preparation work of device DD0 indicated by device identification information DID1 is completed by the worker, informing section 72 can display production continuable time TM0 for device DD0 to be prepared next by the worker (in the same drawing, device DD0 indicated by device identification information DID2).

Then, informing section 72 stops displaying the information related to device DD0 indicated by device identification information DID1 for which the preparation work has been completed, and moves up and displays the information related to device DD0 indicated by device identification information DID2 to device identification information DID4. Further, informing section 72 can display information related to device DD0 to be prepared by the worker next to device DD0 indicated by device identification information DID4 in the lowermost stage.

In this way, informing section 72 can inform about the information related to device DD0 and production continuable time TM0 in the order of devices DD0 prepared by the worker. As a result, the worker can recognize both of the information related to device DD0 to be prepared and production continuable time TM0. Therefore, the worker can acquire the information related to device DD0 and perform the preparation work of device DD0 while paying attention to production continuable time TM0.

Further, as a grace time (production continuable time TM0) from the current time (time T0 illustrated in FIG. 6 or 7) to a work completion time (time T10 illustrated in FIG. 6 or time T25 illustrated in FIG. 7) by which the worker has to complete the preparation work of device DD0 becomes shorter, the worker needs to quickly perform the preparation work of device DD0. Therefore, informing section 72 can change the method of informing about production continuable time TM0 in accordance with the grace time from the current time to the work completion time by which the worker has to complete the preparation work of device DD0. This makes it easier for the worker to recognize production continuable time TM0.

For example, when the grace time is shorter than a reference time at which a warning is necessary for the worker for the preparation work of device DD0, informing section 72 changes the method of informing about production continuable time TM0 so as to alert the worker. When the grace time is over, informing section 72 changes the method of informing about production continuable time TM0 such that the worker immediately performs the preparation work of device DD0. In any case, informing section 72 can change a background color of region 85a for informing about production continuable time TM0 in display device 85.

Specifically, when the grace time is equal to or longer than the reference time, informing section 72 can display the background color of region 85a for informing about production continuable time TM0 in green, for example. Further, when the grace time becomes shorter than the reference time, informing section 72 can display the background color of region 85a for informing about production continuable time TM0 in yellow, for example. As a result, the worker is more likely to gaze at production continuable time TM0 than when the grace time is equal to or longer than the reference time.

Further, when the grace time is over, informing section 72 can display the background color of region 85a for informing about production continuable time TM0 in red, for example. As a result, the worker gazes at production continuable time TM0 as compared with the case where the grace time remains, and the possibility of immediately performing the preparation work of device DD0 increases. The reference time can be set freely. For example, the reference time can be set to a work standard time required when a standard worker performs the preparation work of device DD0.

The reference time can also be set in accordance with the work capacity of the worker. For example, the reference time can be set to a time longer than the work standard time as the work capacity of the worker is lower. Further, the reference time can be set for each production line WL0, or can be set for each production facility including multiple production lines WL0. Further, when the grace time becomes shorter than the reference time, informing section 72 can also inform, using voice, the worker to pay attention to production continuable time TM0. Similarly, informing section 72 can also inform, using voice, the worker to immediately perform the preparation work of device DD0 when the grace time is over.

When the grace time becomes shorter than the reference time, informing section 72 can vibrate mobile terminal 83 to alert the worker. Similarly, informing section 72 can also vibrate mobile terminal 83 to prompt the worker to perform the preparation work of device DD0 when the grace time is over. As described above, informing section 72 can inform about production continuable time TM0 through at least one of the visual sense, the auditory sense, and the tactile sense of the worker.

Informing section 72 can change informing about the preparation work of device DD0 in accordance with the progress status of the preparation work of device DD0 performed by the worker. For example, an indication to scan the device is displayed on the display screen illustrated in FIG. 8. That is, when the worker performs the kitting work, informing section 72 informs the worker to perform the preparation work of device DD0 so as to read the identification code attached to device DD0 using reading device 84 of mobile terminal 83 or the like.

When the identification code attached to device DD0 is read by the worker, informing section 72 informs about the next preparation work for device DD0 on the display screen illustrated in FIG. 8. For example, when device DD0 is feeder 20, when the identification code attached to feeder 20 is read, informing section 72 informs the worker to read the identification code attached to reel 23 using reading device 84 of mobile terminal 83 or the like. Informing section 72 informs the worker to set reel 23 on feeder 20 and install reel 23 at a predetermined position of shelf 82.

In addition, when the worker performs the arrangement preparation work, informing section 72 performs informing such that feeder 20 in which reel 23 is set and which is installed at a predetermined position of shelf 82 is moved to a predetermined slot of cart 40b. As described above, informing section 72 can change informing about the preparation work of device DD0 in accordance with a progress status of the preparation work of device DD0 performed by the worker. Accordingly, the worker can easily recognize the preparation work of device DD0 to be performed next.

Board work machine WM0 of the embodiment includes first slot 12a and second slot 12b. Production line WL0 includes storage device 50 and conveyance device 40a. Article MD0 remaining in production line WL0 is article MD0 that can be supplied from device DD0 held in any of first slot 12a, second slot 12b, and storage device 50. Therefore, in production line WL0, device DD0 is held in advance in second slot 12b and storage device 50, so that production continuable time TM0 can be lengthened.

Further, the worker can perform the preparation work of device DD0 without distinguishing whether device DD0 to be supplied to storage device 50 is used by the changeover work of board work machine WM0 or the replenishing work of device DD0 to board work machine WM0. Further, even when the production plan includes multiple unit productions, production informing device 70 can inform about production continuable time TM0 without distinguishing the multiple unit productions.

### 1-4-3. Others

In the present description, feeder 20 is described as an example of device DD0. However, device DD0 is not limited to feeder 20. As described above, device DD0 may be, for example, the tray unit, the solder container, or the like.

Further, conveyance device 40a of the embodiment is provided to be able to travel on traveling path 30R extending in the conveyance direction (X direction) of board 90. Similarly to cart 40b, conveyance device 40a may be an automated guided vehicle, an autonomous mobile robot, or the like. In this case, production line WL0 can include cart 40b instead of exchange system 30 and conveyance device 40a. The matters described in the present description can be selected as appropriate and applied. Further, the matters described in the present description can be combined as appropriate.

### 2. Production Informing Method

The above description regarding production informing device 70 can be similarly applied to the production informing method. Specifically, the production informing method includes a calculation step and an informing step. The calculation step corresponds to the control performed by calculation section 71. The informing step corresponds to the control performed by informing section 72. The production informing method is executed by the management device through the processing of the management device.

### 3. Example of Effects of Embodiment

With production informing device 70, it is possible to inform the worker about production continuable time TM0. Therefore, the worker is able to understand production continuable time TM0 and can recognize the deadline for preparing device DD0. The above description regarding production informing device 70 can be similarly applied to the production informing method.

### REFERENCE SIGNS LIST

12a: first slot, 12b: second slot, 40a: conveyance device, 50: storage device, 70: production informing device, 71: calculation section, 72: informing section, 85: display device, 85a: region, 90: board, 900: product board, DD0: device, MD0: article, TM0: production continuable time, WL0: production line, WM0: board work machine.

1. A production informing device comprising:
a calculation section configured to, based on the remaining number of articles suppliable from a device used in a board work machine configured to perform predetermined board work on a board to produce a product board, in an entire production line including the board work machine, calculate a production continuable time that is a time during which the board work machine is capable of continuing the production of the product board using the articles remaining in the production line; and
an informing section configured to inform a worker of the production line about the production continuable time calculated by the calculation section.

2. The production informing device according to claim 1, wherein the production line continuously produces the product boards of the same type, and
the calculation section calculates the production continuable time based on the remaining number of the articles in the entire production line and a scheduled number of the articles to be used per unit time.

3. The production informing device according to claim 1,
wherein the production line produces the product board based on a production plan in which a type, a production quantity, and a production period of the product board to be produced, and the device to be used for the production of the product board are planned, and
the calculation section calculates the production continuable time based on the remaining number of the articles in the entire production line and a scheduled number of the articles to be used, which is expected when the product board is produced in accordance with the production plan.

4. The production informing device according to claim 1, wherein the calculation section generates a list of the devices to be prepared by the worker, and
the informing section informs about information related to the devices and the production continuable time in order of the devices prepared by the worker.

5. The production informing device according to claim 1, wherein the informing section changes a method of informing about the production continuable time in accordance with a grace time from a current time to a work completion time by which the worker has to complete preparation work for the devices.

6. The production informing device according to claim 5, wherein the informing section changes the method of informing about the production continuable time so as to alert the worker when the grace time becomes shorter than a reference time at which a warning is necessary for the worker for the preparation work for the devices.

7. The production informing device according to claim 5, wherein the informing section changes the method of informing about the production continuable time such that the worker immediately performs the preparation work for the devices when the grace time is over.

8. The production informing device according to claim 5, wherein the informing section changes a background color of a region for informing about the production continuable time in a display device.

9. The production informing device according to claim 1, wherein the informing section changes informing about the preparation work for the devices in accordance with a progress status of the preparation work for the devices performed by the worker.

10. The production informing device according to claim 1,
wherein the board work machine includes
a first slot capable of holding the device to be used for the production of the product board, and
a second slot capable of preliminarily holding the device that is scheduled to be used for the production of the product board or capable of temporarily holding the device that is no longer necessary for the production of the product board,
the production line includes
a storage device capable of preliminarily holding the device that is scheduled to be used for the production of the product board or capable of temporarily holding the device that is no longer necessary for the production of the product board, and
a conveyance device configured to supply the device carried in the storage device to the first slot or the second slot and collect the device that is no longer necessary for the production of the product board from the first slot or the second slot to the storage device, and
the article remaining in the production line is the article that is suppliable from the device held in any of the first slot, the second slot, and the storage device.

11. A production informing method comprising:
a calculation step of, based on the remaining number of articles suppliable from a device used in a board work machine configured to perform predetermined board work on a board to produce a product board, in an entire production line including the board work machine, calculating a production continuable time that is a time during which the board work machine is capable of continuing the production of the product board using the articles remaining in the production line; and
an informing step of informing a worker of the production line about the production continuable time calculated by the calculation step.
